(19) United States
(12) Patent Application Publication
(10) Pub. No.: US 2026/0350913 A1
(43) Pub. Date: Nov. 5, 2026

(54) METHODS AND DEVICES FOR RENDERING CHANGEABLE CONTENTS ON A VIRTUAL SCREEN IN A 3D VIRTUAL SCENE

(71) Applicant: HUAWEI TECHNOLOGIES CO., LTD., Shenzhen (CN)

(72) Inventors: Zihao YANG, Kanata (CA); Jizong Peng, Kanata (CA); Freeman Cheng, Kanata (CA); Peng Dai, Kanata (CA); Juwei Lu, Kanata (CA); Zhihao Li, Shenzhen (GD); Youliang Yan, Shenzhen (CN)

(21) Appl. No.: 19/565,914

(22) Filed: Mar. 13, 2026

Related U.S. Application Data
(63) Continuation of application No. PCT/CN2023/119550, filed on Sep. 19, 2023.

(51) Int. Cl. G06T 15/08; G06T 17/00; G06T 19/20

(52) U.S. Cl. CPC G06T 15/08; G06T 17/00; G06T 19/20; G06T 2219/2004

(57) ABSTRACT

A method performed by an apparatus has the step of rendering changeable contents on a virtual screen in a three-dimensional (3D) scene. In some implementations, the virtual screen is formed by a group of individual distributions each belonging to the family of elliptical distributions, or is formed by 3D Gaussians.

### CROSS-REFERENCE TO RELATED APPLICATION

This application is a continuation of PCT International Patent Application Serial No. PCT/CN2023/119550 filed on Sep. 19, 2023, the content of which is incorporated herein by reference in its entirety.

### TECHNICAL FIELD

The present disclosure relates generally to 3D computer vision and image/picture processing.

### BACKGROUND

Neural Radiance Fields (NeRF) are one of the most popular techniques that can generate novel views of complex three-dimensional (3D) scenes, based on a set of two dimensional (2D) images. It's well known for its ability to render photo-realistic scenes.

There are two major drawbacks for NeRF-based methods compared to Computer graphics (CG) based ones. One is the difficulty to edit the scene and another is the high computational complexity, which makes it difficult to render in real time. Recently the so-called “3D Gaussian Splatting” (3DGS) technique has been proposed to significantly reduce the computational complexity and shows promising editing capability. However, it is still challenging to render dynamic content in 3D scenes.

### SUMMARY

In this disclosure, there is provided a method to create a virtual screen, which can render real-time dynamic contents in a virtual 3D world.

In one aspect, the disclosure discloses a method to create one or multiple virtual screens in the form of 3D Gaussians. They look like LED screens in the physical world, and thus are referred to as virtual LED screen(s) or virtual screen(s). The size, resolution and location of the virtual LED screen(s) are customized based on user requirements. Further, the virtual LED screen(s) are used to render dynamically changing contents. In addition, an individual 3D Gaussian in the virtual LED screen corresponds to (one or multiple) pixels of a region in a frame of an input video. The color of each Gaussian automatically changes frame by frame as the video is streaming.

In another aspect, the disclosure discloses a method comprising: rendering changeable contents on a virtual screen in a 3D scene. Optionally, wherein the virtual screen is formed by a group of individual distributions, each belonging to the family of elliptical distributions. Optionally, wherein the virtual screen is formed by 3D Gaussians or Student's t-distributions. In one possible embodiment, the videos of a significant moment, e.g. wedding, can be streamed with the 3D reconstruction of the place of the event, e.g. church.

In one possible implement, before rendering, the method further comprises: creating the virtual screen in the 3D scene. For example, the 3D scene comprises at least one of: virtual scene reconstructed by computer graphics (CG) or artificial intelligence (AI), Augmented reality (AR), Mixed Reality (MR), or Virtual Reality (VR) techniques.

In another possible implement, wherein the method of creating the screen in the 3D scene comprises: defining, based on parameters of the screen, a region to form the virtual screen in the 3D scene. For example, the user can mask out a region in the point cloud to be replaced by the screen; in this case, all parameters of the screen are inferred from the mask. The user can optionally fine-tune these parameters through a user-interface with live previews of the generated screen to their liking. In another example, in the case of the screen being rectangular, the user can specify the aspect ratio, the resolution, and the positions of any two corners of the screen. Optionally, the user may provide the thickness of the screen. Additionally, the user is provided a user-interface with live feedback for fine-tuning.

In another possible implement, wherein the method of creating the virtual screen in the 3D scene comprises: arranging the 3D Gaussians in the defined region based on a pattern. FIG. 3 describes one possible way to arrange the 3D gaussians in the defined region.

In another possible implement, wherein the method of creating the virtual screen in the 3D scene comprises: arranging or distributing the 3D Gaussians in a region based on parameters of the virtual screen.

In another possible implement, wherein the parameters comprise at least one of: pattern of 3D Gaussians arrangement; the location of the virtual screen; the orientation of the virtual screen; the resolution of the virtual screen; the size of the virtual screen; and the shape of the virtual screen.

In another possible implement, wherein the pattern is designed to evenly distribute the 3D Gaussians in the region.

In another possible implement, wherein the pattern is designed to adaptively distribute the 3D Gaussians in the region based on the changeable content to be displayed on the virtual screen.

In another possible implement, wherein the pattern is designed to distribute the 3D Gaussian in the region based on a rule. For example, a rule can be to dynamically distribute the 3D Gaussians based on the user's attention by having more 3D Gaussians at the area the user is focusing on. A device such as an eye tracker can be used to determine the user's area of focus.

In another possible implement, wherein resolution of the virtual screen is determined by the number of the 3D Gaussians. The more 3D Gaussians on the virtual screen, the high resolution the virtual screen has.

In another possible implement, wherein the changeable contents comprise at least one of: video; audio; picture; and text.

In another aspect, the disclosure discloses a method to dynamically change the content of the virtual screen at rendering time, where the streaming of the content can be paused, fast forwarded and restarted with full control from the user.

In one possible implement, wherein the rendering of the 3D Gaussians is achieved by a Compute Unified Device Architecture (CUDA) rasterizer. For example, at each frame, the pixel colors are first read from either a pre-decoded video or decoded with a real time video decoder and then assigned to the corresponding 3D Gaussians using an ID mask. The opacity of these 3D Gaussians can also be modified at each frame to change the visibility of the virtual screen, thereby achieving the ability to turn the screen on/off.

In another possible implement, wherein the user is given optional control of all the parameters of the 3D Gaussians forming the screen, thus enhancing the user experience. For example, the user may choose to move the screen at will. In another example, the user may choose to warp or manipulate the output on the screen at will. One possibility is to apply image filters such as the: black and white” or “deep fried” filter.

In another possible implement, wherein the rendering of the 3D Gaussians is achieved by drawing each gaussian splat as a screenspace aligned rectangle that covers the extents of it.

In another possible implement, location of the virtual screen will be changed when a move command is detected or received.

In another possible implement, a corresponding operation is performed based on received operation command, wherein the operation command comprises at least one of pause command, fast forward command, load next content command and restart command.

In another possible implement, before rendering changeable contents on a virtual screen in a three-dimensional (3D) scene, further comprising: rendering the virtual screen in a 3D scene; wherein rendering changeable contents on a virtual screen in a 3D scene comprises: rendering the content on the virtual screen in the 3D scene when detecting a playing command. Optionally, rendering the virtual screen in a 3D scene comprises: rendering the virtual screen and setting the screen to transparent. When the virtual screen is in the transparent state, the virtual screen can't be seen by a user.

In another possible implement, the visibility of the virtual screen is changed based on opacity of the 3D Gaussians.

In another aspect, the disclosure discloses a device or an apparatus, comprising a processor, wherein the processor is configured to call and run computer execution instructions stored in a memory, to enable a to execute the above method. For example, the device or apparatus is a device with display screen, such as smart phone, smart screen, intelligent car, Head Mounted Devices (HMD), Wearable devices.

In another aspect, the disclosure discloses a device or an apparatus, comprising a processor and a screen coupled to the processor, wherein the processor is configured to call and run computer execution instructions stored in a memory, to enable a to execute the above method. For example, the device or apparatus is a device with display screen, such as smart phone, smart screen, intelligent car, Head Mounted Devices (HMD), Wearable devices.

In another aspect, the disclosure discloses a chip, comprising an input/output (I/O) interface and a processor, wherein the processor is configured to call and run computer execution instructions stored in a memory, to enable a device installing with the chip to execute the above method.

In another aspect, the disclosure discloses a computer-readable medium storing computer execution instruction which, when executed by a processor, causes the processor to execute the above method.

In another aspect, the disclosure discloses a computer program product comprising computer execution instructions which, when executed by a processor, causes the processor to execute the above method. In one possible embodiment, the ellipsoids used in 3D Gaussian splatting can be generated with other distributions. For example, any distribution in the family of elliptical distributions may be used, such as the Student's t-distribution.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 is a sample point cloud for representing a real scene. The rectangle shaped region corresponds to a LED screen;

FIG. 2 is a schematic illustration of System diagram for content to LED mapping;

FIG. 3 is a schematic illustration of creating a virtual LED screen at a targeted location according to one or more embodiments of the present disclosure;

FIG. 4 is a schematic illustration of content (e.g. video) to LED mapping according to one or more embodiments of the present disclosure;

FIG. 5 is an illustration of one possible design of a virtual LED;

FIG. 6 is a schematic illustration of a device according to one or more embodiments of the present disclosure.

### DETAILED DESCRIPTION

For illustrative purposes, specific example embodiments will now be explained in greater detail below in conjunction with the figures.

3D Gaussian Splatting (3DGS) is the state of the art (SOTA) for neural rendering. 3DGS utilizes a group of 3D Gaussians to model the 3D scene. It provides a new way to model 3D environment with real time rendering performance. Our invention is also based on 3DGS technique.

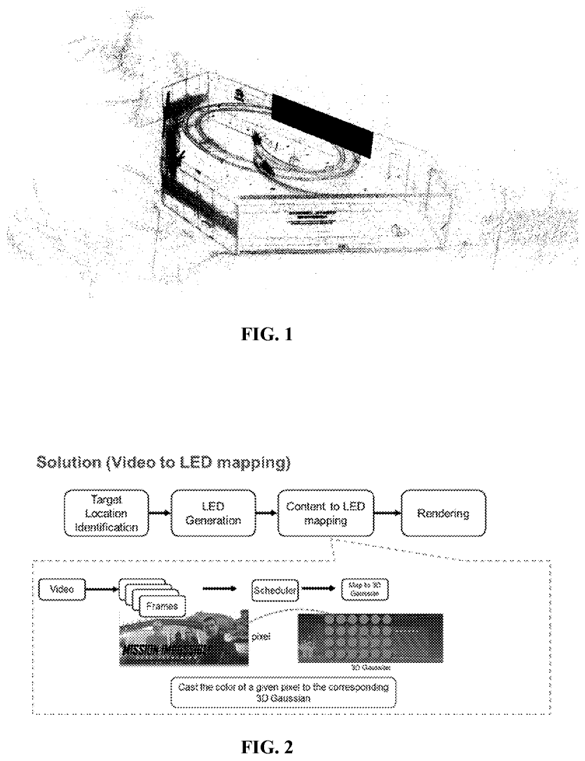

Referring to FIG. 1, unlike NeRF, which is based on multilayer perceptron (MLP), 3DGS utilizes point cloud to represent the physical world. Thus, we can naturally make use of the physical meaning and the corresponding 3D information for editing, for example, simulating a virtual LED screen (virtual screen or LED or LED screen) with 3DGS in a 3D scene.

Referring to FIG. 2, it's an overview of the disclosed system, which consists of the following components:
Target location identification, which locates a region for a virtual LED screen in a 3D scene.
LED generation, which creates a virtual LED screen at the target location based on the LED screen parameters that users input such as the location, size, orientation, resolution, and shape of the LED screen
Content to LED mapping, which processes the content such as videos and images to fit the size of the virtual LED screen, and match the rendering speed (frame rate) of the virtual LED screen if the content is audio.
Rendering, which renders the processed content in the virtual LED screen together with the 3D scene.

In various embodiments, an array of 3D Gaussians may be used to create a virtual LED screen with changeable contents during rendering. The 3D Gaussians are distributed on the LED region following a predefined pattern. In one embodiment, the pattern is designed to evenly distribute the 3D Gaussians across the LED region. In another embodiment, the pattern is designed to distribute the 3D Gaussians according to the content with more dense 3D Gaussians are assigned to more detailed regions of the content. Each 3D Gaussian has a predefined location (mean) and Gaussian covariance, and corresponds to a local region of the display content, for example, pixels of a video frame. By manipulating the parameters of each 3D Gaussian such as its color according to the pixel color of an input video frame, the virtual LED screen can dynamically render the video from frame to frame.

The virtual LED screen can be created at a target location based on the LED screen parameters that users input in a virtual 3D scene reconstructed by computer graphics or artificial intelligence techniques, Augmented reality (AR) scene, or Virtual Reality (VR) scene. The intended contents, such as videos and images, are then sent to the LED screen to render with or without their corresponding audio.

Referring to FIG. 2, in one possible embodiment we preprocess the point clouds for easier editing. NeRF reconstructed scene sometimes is not up straight. For better user experience, we usually unify the directions of the scene. In one possible embodiment Principal Component Analysis (PCA) is used to find the correct direction of the scene. The leading 3 eigen vectors are considered as the xyz axis. The 3rd eigen vector is heuristically set as the height direction, i.e. y-axis. In one possible embodiment, we remove points that are further away from their neighbors compared to the average for the point cloud.

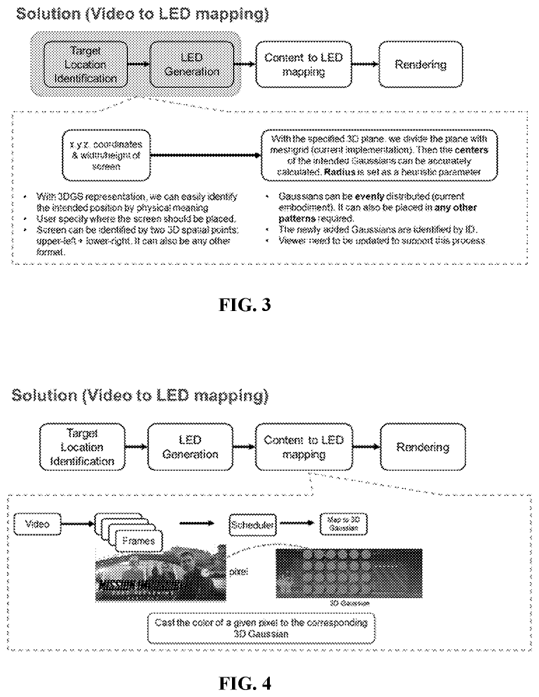

Referring to FIG. 3, it's a solution for video to LED mapping. The key part of our invention is to create the virtual LED screen and put it at the correct place, e.g., AR/VR scenes.

The intended location of the LED screen can be identified in any format that identifies a 3D plane. In our current implementation, the screen is up straight, i.e. parallel to the vertical axis. In one implementation, we need two points, i.e., upper-left and lower-right, to identify the plane. In another implementation, it could also be 3 points, 1 point+direction, etc.

Given the location and area of the plane, we distribute 3D gaussians following a given pattern. In our current implementation, we evenly distribute the gaussians across the area. We also simplify the 3D gaussians to be ball-shaped, which can be represented simply by center+radius. For other use cases, we can distribute the gaussians in any pattern. The gaussians can also be ellipse.

Referring to FIG. 4, with the layer of 3D Gaussians fitted, we map the RGB (red, green and blue primary colors of light) colors of video frames to the corresponding gaussian balls according to 2D locations. The colors of each ball are updated as frames change.

Referring to FIG. 4, the intended location of the LED screen can be identified in any format that identifies a 3D plane. In our current implementation, the screen is up straight, i.e. parallel to the vertical axis. Thus, we only need two points, i.e., upper-left and lower-right, to identify the plane. For other use cases, it could also be 3 points, 1 point+direction, etc.

Referring to FIG. 4, given the location and area of the plane, we distribute 3D gaussians following a given pattern. In our current implementation, we evenly distribute the gaussians across the area. In one possible embodiment, we simplify the covariance of 3D Gaussians to be sphere, which can be represented simply by center together with radius. The center and radius of each 3D Gaussian are defined based on the screen parameters. We arrange more 3D Gaussians and smaller radius for higher-resolution LED screens. For other use cases, we can distribute the gaussians in any pattern. The shape of 3D Gaussians does not need to be limited as sphere, which can be changed by changing parameters of ellipse.

In one possible embodiment, the shape of 3D Gaussians can be set as ellipse. The longer axis can be set along the normal direction of the LED plane. Thus, it gives a feeling of thickness to the LED screen.

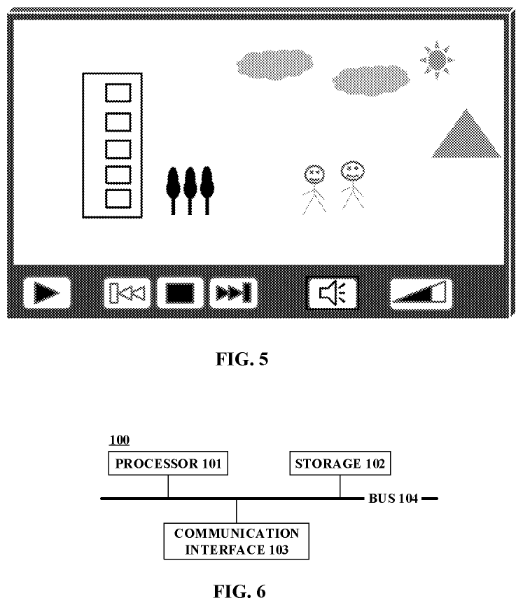

Referring to FIG. 5, in one possible embodiment, the virtual LED screen contains all necessary functions of a typical video player, including Play, Stop, Fast Forward, Fast Backward, Mute, Change Volume.

The splatting of the 3D Gaussians and the rasterization process renders an output image, and the color, C, of each pixel on the rendered image can be calculated as follows,

$$C = {\sum }_{i ∈ N} {c}_{i} {a}_{i} {\prod }_{j = ⌉}^{i - 1} ( 1 - {a}_{j} )$$

where N represents the indices of 3D Gaussians overlapping each pixel on a rendered image, in ascending order of distance to the pixel; cᵢ refers to the color calculated from learned spherical harmonic coefficients associated to i-th 3D Gaussian; aᵢ is calculated by evaluating a 2D Gaussian derived from i-th 3D Gaussian multiplied by a learned or predefined or user-defined opacity a associated to i-th 3D Gaussian.

As shown in FIG. 6, an electronic device 100 includes one or more processors 101, a memory 102, a communication interface 103, a bus 104 and a screen.

The processor 101 may include one or more processing units, for example, the processor 101 may include CPU (central processing unit), AP (application processor), GPU (graphics processing unit), ISP (image signal processor), DSP (digital signal processor), NPU (neural-network processing unit), ASIC (application-specific integrated circuit), and the like. The different processing units may be separate devices or may be integrated in one or more processors.

In some embodiments, the processor 101 may be configured to execute instructions to implement the model training methods provided by various embodiments of the present disclosure or implement the functions of the model training apparatus 10.

For example, the processor 101 may be configured to execute instructions to: render changeable contents on a virtual screen in a three-dimensional (3D) scene.

Memory 102 may include volatile memory and non-volatile memory for storing data and instructions.

The volatile memory may include RAM (random-access memory), DDR SDRAM (double data rate synchronous dynamic random access memory), and the like. The volatile memory is employed to temporarily store data and/or instructions Which may be used to temporarily store instructions for execution by processor 101.

The non-volatile memory may include one or more tangible, non-transitory computer-readable media for storing data and/or instructions. In some embodiments, the nonvolatile memory may include any suitable nonvolatile memory, such as flash memory, and/or any suitable nonvolatile storage device, such as HDD (hard disk drive), CD (compact disc), DVD (digital versatile disc), SSD (solid-state drive), and the like.

In some embodiments, the non-volatile memory may also be a removable storage medium.

In some embodiments, the non-volatile memory may be employed to permanently store instructions for execution by the processor 101.

In particular, the volatile memory and the non-volatile memory in the memory 102 may include a temporary copy and a permanent copy of the instruction 105, respectively. The instructions 105 may include causing the electronic device 100, when executed by at least one of the processors 101, to perform method provided in the foregoing embodiments.

The communication interface 103 is configured to communicate between electronic devices 100 and other devices.

In some embodiments, communication interface 103 may include a transceiver for providing a wired or wireless communication interface for electronic device 100, such as an interface of an Ethernet, WAN (wireless access network), WLAN (wireless local area networks), or the like.

The bus 104 is used to connect the processor 101, the memory 102, and the communication interface 103 to enable communication between the processor 101, the memory 102, and the communication interface 103.

In other embodiments, the electronic device 100 may also include input/output devices, such as a keyboard, mouse, display screen, and the like.

It will be appreciated that the electronic device 100 may be any electronic device capable of executing instructions, including, but not limited to, a laptop computer, a desktop computer, a tablet computer, a mobile phone, a server, a wearable, an intelligent car and the like, and is not limited herein.

It will be appreciated that the structure of the electronic device 100 shown in the embodiments of the present disclosure does not constitute a specific limitation on the electronic device 100. In other embodiments, electronic device 100 may include more or fewer components than shown, or may combine certain components, or may split certain components, or may have different component arrangements. The illustrated components may be implemented in hardware, software, or a combination of software and hardware.

1. A method performed by an apparatus comprising:
rendering changeable contents on a virtual screen in a three-dimensional (3D) scene.

2. The method of claim 2, wherein the virtual screen is formed by a group of individual distributions each belonging to the family of elliptical distributions, or is formed by 3D Gaussians.

3. The method of claim 2, wherein the virtual screen is formed by the 3D Gaussians;
wherein, before rendering, the method further comprises:
creating the virtual screen in the 3D scene; and
wherein said creating the virtual screen in the 3D scene comprises:
defining, based on parameters of the screen, a region to form the virtual screen in the 3D scene; or
arranging or distributing the 3D Gaussians in a region based on parameters of the virtual screen to form the virtual screen in the 3D scene.

4. The method of claim 3, wherein the virtual screen parameters comprise pattern of 3D Gaussians arrangement; and
wherein the pattern of 3D Gaussians arrangement is designed to:
evenly distribute the 3D Gaussians in the region;
adaptively distribute the 3D Gaussians in the region based on the content to be displayed on the virtual screen; or
distribute the 3D Gaussian in the region based on a user's attention.

5. The method of claim 2, wherein the virtual screen is formed by the 3D Gaussians; and
wherein resolution of the virtual screen is determined by the number of the 3D Gaussians.

6. The method of claim 1, further comprising:
changing location of the virtual screen when detecting or receiving a move command.

7. A device, comprising a processor and a screen coupled to the processor, wherein the processor is configured to call and run computer execution instructions stored in a memory, to perform one or more actions comprising:
rendering changeable contents on a virtual screen in a three-dimensional (3D) scene.

8. The device of claim 7, wherein the virtual screen is formed by a group of individual distributions each belonging to the family of elliptical distributions, or is formed by 3D Gaussians.

9. The device of claim 8, wherein the virtual screen is formed by the 3D Gaussians;
wherein the processor is configured to call and run the computer execution instructions stored in the memory, to perform one or more further actions comprising:
before rendering, creating the virtual screen in the 3D scene; and
wherein said creating the virtual screen in the 3D scene comprises:
defining, based on parameters of the screen, a region to form the virtual screen in the 3D scene; or
arranging or distributing the 3D Gaussians in a region based on parameters of the virtual screen to form the virtual screen in the 3D scene.

10. The device of claim 9, wherein the virtual screen parameters comprise pattern of 3D Gaussians arrangement; and
wherein the pattern of 3D Gaussians arrangement is designed to:
evenly distribute the 3D Gaussians in the region;
adaptively distribute the 3D Gaussians in the region based on the content to be displayed on the virtual screen; or
distribute the 3D Gaussian in the region based on a user's attention.

11. A computer-readable medium storing computer execution instructions which, when executed by a processor, causes the processor to perform one or more actions comprising:
rendering changeable contents on a virtual screen in a three-dimensional (3D) scene.

12. The computer-readable medium of claim 11, wherein the virtual screen is formed by a group of individual distributions each belonging to the family of elliptical distributions, or is formed by 3D Gaussians.

13. The computer-readable medium of claim 12, wherein the virtual screen is formed by the 3D Gaussians; and
wherein the computer execution instructions, when executed by the processor, causes the processor to perform one or more further actions comprising:
before rendering, creating the virtual screen in the 3D scene.

14. The computer-readable medium of claim 13, wherein said creating the virtual screen in the 3D scene comprises:
defining, based on parameters of the screen, a region to form the virtual screen in the 3D scene; or
arranging or distributing the 3D Gaussians in a region based on parameters of the virtual screen to form the virtual screen in the 3D scene.

15. The computer-readable medium of claim 14, wherein the virtual screen parameters comprise at least one of:
pattern of 3D Gaussians arrangement;
location of the virtual screen;
orientation of the virtual screen;
resolution of the virtual screen;
size of the virtual screen; and
shape of the virtual screen.

16. The computer-readable medium of claim 15, wherein the pattern of 3D Gaussians arrangement is designed to:
evenly distribute the 3D Gaussians in the region;
adaptively distribute the 3D Gaussians in the region based on the content to be displayed on the virtual screen; or
distribute the 3D Gaussian in the region based on a user's attention.

17. The computer-readable medium of claim 12, wherein the virtual screen is formed by the 3D Gaussians; and
wherein resolution of the virtual screen is determined by the number of the 3D Gaussians.

18. The computer-readable medium of claim 11, wherein the computer execution instructions, when executed by the processor, causes the processor to perform one or more further actions comprising:
changing location of the virtual screen when detecting or receiving a move command.

19. The computer-readable medium of claim 11, wherein the computer execution instructions, when executed by the processor, causes the processor to perform one or more further actions comprising:
performing corresponding operation based on received operation command, wherein the operation command comprises at least one of pause command, fast forward command, load next content command and restart command.

20. The computer-readable medium of claim 11, wherein the computer execution instructions, when executed by the processor, causes the processor to perform one or more further actions comprising:
changing opacity of the 3D Gaussians to change the visibility of the virtual screen.
